(19) United States
(12) Patent Application Publication
(10) Pub. No.: US 2015/0244251 A1
(43) Pub. Date: Aug. 27, 2015

(54) INVERTING APPARATUS AND DETECTION METHOD OF ISLANDING OPERATION

(71) Applicant: FSP TECHNOLOGY INC., Taoyuan City (TW)

(72) Inventors: Han-Wei Chen, Taoyuan City (TW); Chun-Hao Yu, Taoyuan City (TW); Chia-Hua Liu, Taoyuan City (TW)

(21) Appl. No.: 14/630,648

(22) Filed: Feb. 25, 2015

Related U.S. Application Data
(60) Provisional application No. 61/944,587, filed on Feb. 26, 2014.

(30) Foreign Application Priority Data
Jan. 27, 2015 (CN) 201510039854.5

(51) Int. Cl. H02M 1/32

(52) U.S. Cl. CPC H02M 1/32

(57) ABSTRACT

An inverting apparatus and a detection method of an islanding operation are provided. The inverting apparatus includes an inverting circuit and a control circuit; the inverting circuit is connected to a power grid, wherein the inverting circuit receives a DC input power, and converts the DC input power into an AC output voltage and an AC output current; the control circuit is coupled to the inverting circuit; the control circuit is configured to control the power conversion of the inverting circuit, wherein the control circuit generates a disturbance signal base on a preset time interval to disturb the AC output current generated by the inverting circuit, and detects whether the frequency of the AC output voltage is located within a preset frequency range, so as to decide whether to enable an islanding protection mechanism.

### CROSS-REFERENCE TO RELATED APPLICATION

This application claims the priority benefits of U.S. provisional application Ser. No. 61/944,587, filed on Feb. 26, 2014 and China application serial no. 201510039854.5, filed on Jan. 27, 2015. The entirety of each of the above-mentioned patent applications is hereby incorporated by reference herein and made a part of this specification.

### BACKGROUND OF THE INVENTION

1. Field of the Invention

The invention relates to a power conversion technique, and more particularly, to an inverting apparatus and a detection method of an islanding operation.

2. Description of Related Art

To reduce the consumption rate of fossil energy, applications in renewable energy are actively developed for current power systems. In current applications, a grid AC power distribution system is the mainstream trend of current power system development, and the grid AC power distribution system can use renewable energy generation such as solar power generation and wind power generation as a small distributed power system, and the distributed power system is connected to a power grid, so as to supply power to a back-end load device together for use.

However, a current and inevitable issue of such an AC power distribution system is that a phenomenon of islanding operation often occurs in the distributed power system. More specifically, in such an AC power distribution system, the power grid disconnects the connection with the inverting apparatus of the distributed power system and the back-end load device when abnormality occurs during power supply or when maintenance is performed, such that the power grid is isolated from the AC power distribution system. At this time, if the inverting apparatus does not detect the power grid is isolated from the AC power distribution system and continuously supplies power to only the load device, then such as phenomenon is generally referred to as an islanding operation. In an islanding operation, since the power provided by the distributed power system is unstable, damage to the load device may occur.

### SUMMARY OF THE INVENTION

The invention provides an inverting apparatus and a detection method of an islanding operation capable of accurately detecting whether an islanding operation occurs to the inverting apparatus.

An inverting apparatus of the invention includes an inverting circuit and a control circuit. The inverting circuit is connected to a power grid, wherein the inverting circuit receives a DC input power, and converts the DC input power into an AC output voltage and an AC output current. The control circuit is coupled to the inverting circuit and configured to control the power conversion of the inverting circuit, wherein the control circuit generates a disturbance signal base on a preset time interval to disturb the AC output current generated by the inverting circuit, and detects whether the frequency of the AC output voltage is located within a preset frequency range, so as to decide whether to enable an islanding protection mechanism.

In an embodiment of the invention, the control circuit determines whether the frequency of the AC output voltage is located within the preset frequency range according to the zero-voltage cycle of the AC output voltage.

In an embodiment of the invention, the current cycle of the AC output current is changed by a disturbance signal; when the power grid is in normal operation and connected to the inverting circuit, the zero-voltage cycle is not affected by the change in the current cycle, and when the power grid is abnormal and disconnected from the inverting circuit, the zero-voltage cycle is changed with a change in the current cycle.

In an embodiment of the invention, the inverting circuit adjusts the power conversion behavior in response to the disturbance signal, and thus reduces or extends the current cycle.

In an embodiment of the invention, the inverting circuit suspends the power conversion in response to the disturbance signal, and thus reduces the current cycle.

In an embodiment of the invention, the control circuit includes a zero-voltage detection unit, a frequency detection unit, a protection unit, and a drive control unit. The zero-voltage detection unit is coupled to the output terminal of the inverting circuit and is configured to detect the zero-voltage time point of the AC output voltage. The frequency detection unit is coupled to the zero-voltage detection unit and is configured to calculate the zero-voltage cycle according to the zero-voltage time point of the AC output voltage. The protection unit is coupled to the frequency detection unit and is configured to determine whether the frequency of the AC output voltage is located within the preset frequency range according to the zero-voltage cycle, and sends a protection signal when the frequency of the AC output voltage is not located within the preset frequency range. The drive control unit is coupled to the protection unit and is configured to enable the islanding protection mechanism according to the protection signal, so as to control the operation of the inverting circuit.

A detection method of an islanding operation of the invention is suitable for an AC power distribution system, wherein the AC power distribution system includes an inverting apparatus and a power grid, the inverting apparatus is connected to the power grid, and the detection method includes the following steps: a DC input power is received by the inverting apparatus; the DC input power is converted into an AC output voltage and an AC output current by the inverting apparatus; a disturbance signal is generated base on a preset time interval to disturb the AC output current generated by the inverting apparatus; whether the frequency of the AC output voltage is located within a preset frequency range is detected; and when the frequency of the AC output voltage is not located within the preset frequency range, an islanding operation phenomenon is determined to occur to the inverting apparatus.

In an embodiment of the invention, the step of detecting whether the frequency of the AC output voltage is located within the preset frequency range includes: detecting the zero-voltage time point of the AC output voltage; calculating the zero-voltage cycle according to the zero-voltage time point of the AC output voltage; and determining whether the frequency of the AC output voltage is located within the preset frequency range according to the zero-voltage cycle.

In an embodiment of the invention, the step of generating the disturbance signal base on the preset time interval to disturb the AC output current generated by the inverting apparatus includes: making the inverting circuit respond to the disturbance signal to adjust the power conversion behavior thereof so as to shorten or extend the current cycle.

In an embodiment of the invention, the step of making the inverting circuit respond to the disturbance signal to adjust the power conversion behavior thereof so as to shorten or extend the current cycle includes: making the inverting circuit respond to the disturbance signal to stop power conversion so as to shorten the current cycle.

In an embodiment of the invention, the detection method of an islanding operation includes the following steps: an islanding protection mechanism is enabled when an island operation phenomenon is determined to occur to the inverting apparatus.

Based on the above, the embodiments of the invention provide an inverting apparatus and a detection method of an islanding operation. The inverting apparatus can determine whether an islanding operation occurs to the inverting apparatus in a manner in which the inverting apparatus periodically disturbs the AC output current and then detects whether the AC output voltage is changed as a result, so as to accurately and instantly enable an islanding protection mechanism when the islanding operation occurs to prevent damage to a back-end load device.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of an AC power distribution system and an inverting apparatus of an embodiment of the invention.

FIG. 2 is a flow chart of the steps of a detection method of an islanding operation of an embodiment of the invention.

FIG. 3 is a functional block schematic of a control circuit of an embodiment of the invention.

FIG. 4A is a voltage waveform schematic of an AC output voltage of an embodiment of the invention.

FIG. 4B is a voltage waveform schematic of an AC output voltage of an embodiment of the invention.

### DESCRIPTION OF THE EMBODIMENTS

To make the contents of the invention more easily understood, embodiments are provided below as examples of the invention. Moreover, when applicable, devices/components/steps having the same reference numerals in figures and embodiments represent the same or similar parts.

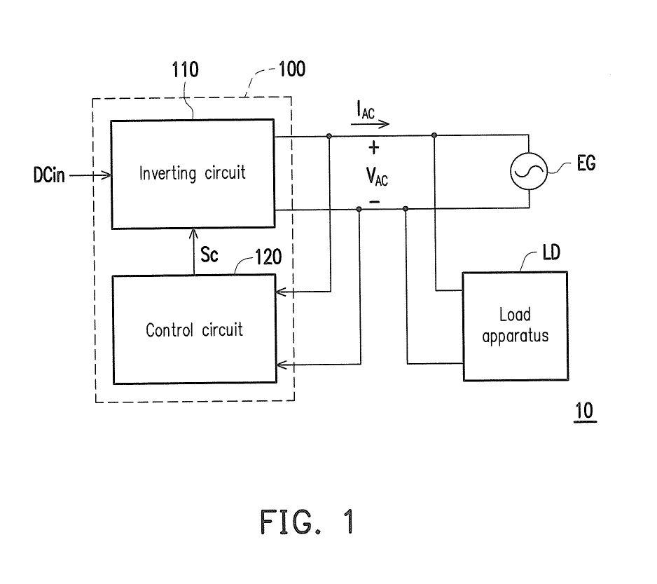

FIG. 1 is a schematic of an AC power distribution system and an inverting apparatus of an embodiment of the invention. Referring to FIG. 1, an inverting apparatus 100 of the present embodiment can be applied in an AC power distribution system 10. In the AC power distribution system 10 of the present embodiment, the input terminal of the inverting apparatus 100 is coupled to a DC power generating apparatus (such as a renewable energy power generation component) such as a photovoltaic component (not shown), a wind power generation component, or a hydroelectric power generation component, and the output terminal of the inverting apparatus 100 is connected to a power grid EG. In particular, the inverting apparatus 100 and a front-end renewable energy power generation component can be viewed as a distributed power system. In FIG. 1, although only one distributed power system is shown, the invention is not limited thereto. In actual application, the AC power distribution system 10 can also contain a plurality of connected distributed power systems.

The inverting apparatus 100 can receive a DC input power DCin from a front-end photovoltaic component and convert the received DC input power DCin into an AC output voltage V_{AC} and an AC output current I_{AC}. Specifically, the inverting apparatus 100 includes an inverting circuit 110 and a control circuit 120. The inverting circuit 110 receives the DC input power DCin and is configured to convert the DC input power into the AC output voltage V_{AC} and the AC output current I_{AC}. In particular, the circuit configuration of the inverting circuit 110 can be, for instance, half-bridge asymmetric, half-bridge symmetric, full-bridge, or other possible inverting circuit configurations, and the invention does not particularly limit the circuit configuration of the inverting circuit 110.

The control circuit 120 is coupled to the inverting circuit 110 and is configured to control the power conversion of the inverting circuit 110, and a control signal Sc generated by the control circuit 120 can be, for instance, configured to a PWM signal for controlling the switching cycle of the inverting circuit 110, but the invention is not limited thereto.

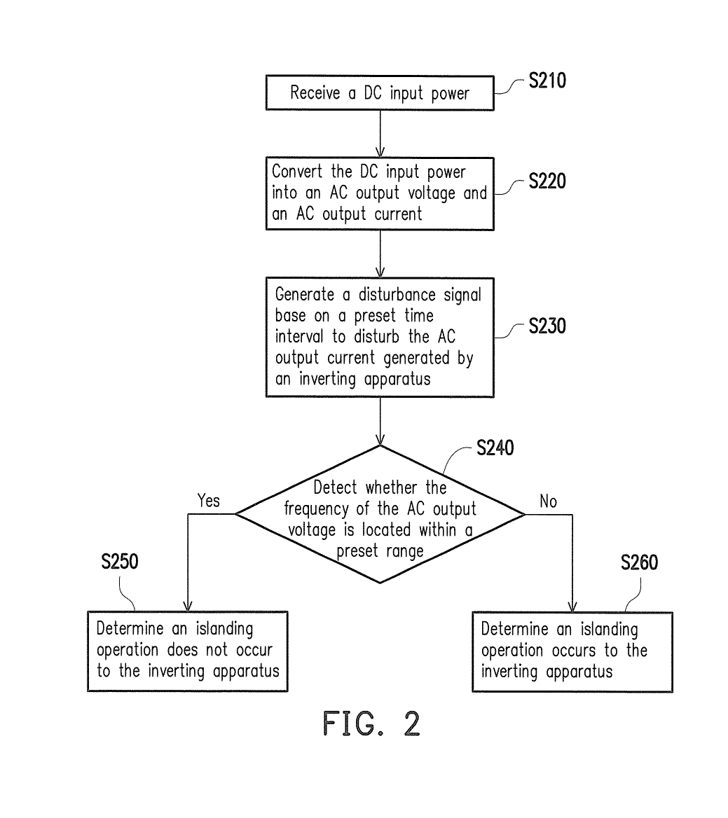

In the AC power distribution system 10 of the present embodiment, the inverting apparatus 100 and the front-end renewable energy power generation component can be viewed as one distributed power system, and is connected to the power grid EG and/or other distributed power systems (not shown) in parallel, so as to provide power to a load device LD together for use. In particular, to make the inverting apparatus 100 accurately detect the occurrence of an islanding operation and thereby execute a corresponding islanding protection mechanism, the inverting apparatus 100 determines whether the islanding operation occurs according to a change in the AC output voltage V_{AC} in a manner in which the inverting apparatus 100 periodically disturbs the outputted AC output current I_{AC} and then detects the AC output voltage V_{AC}. A specific islanding operation detection method is as shown in FIG. 2. In particular, FIG. 2 is a flow chart of the steps of a detection method of an islanding operation of an embodiment of the invention.

Referring to both FIG. 1 and FIG. 2, in the present embodiment, first, the inverting circuit 110 receives a DC input power DCin (step S210), and then converts the DC input power DCin into an AC output voltage V_{AC} and an AC output current I_{AC} (step S220). Then, the control circuit 120 generates a disturbance signal base on a preset time interval to adjust a control signal Sc, so as to disturb the AC output current I_{AC} generated by the inverting circuit 110 (step S230), and further detects whether the frequency of the AC output voltage V_{AC} outputted by the inverting circuit 110 is located within a preset frequency range (step S240).

When the control circuit 120 detects the frequency of the AC output voltage V_{AC} is still located within the preset frequency range, the AC output voltage V_{AC} is still restrained by the voltage of the power grid EG, and frequency change due to the disturbance of current does not occur. As a result, the control circuit 120 determines an islanding operation does not occur to the inverting apparatus 100 at present (step S250). That is, the power grid EG should be in a noinial operating state and connected to the inverting circuit 110.

On the contrary, when the control circuit 120 detects the frequency of the AC output voltage V_{AC} exceeds the preset frequency range, the AC output voltage V_{AC} is no longer restrained by the voltage of the power grid EG, and instead frequency change due to the disturbance of current occurs. As a result, the control circuit 120 determines an islanding operation occurs to the inverting apparatus 100 (step S260). That is, the power grid EG is isolated from the AC power distribution system 10 at this situation.

After the detection of whether an islanding operation occurs to the inverting apparatus 100 is complete, the control circuit 120 can accordingly decide whether to enable an islanding protection mechanism to control the operation of the inverting circuit 110, thus preventing damage to the back-end load device LD. For instance, the inverting circuit 110 can include a protection relay (not shown). When the control circuit 120 determines the islanding operation is occurred and enables the islanding protection mechanism, the control circuit 120 triggers the protection relay, so as to make the inverting apparatus 100 disconnected from the other parts of the AC power distribution system 10 (such as the load device LD), so as to prevent the continuous occurrence of the islanding operation.

Specifically, the control circuit 120 can, for instance, generate 4 disturbance signals in every 40 AC output voltage V_{AC} cycles (not limited thereto, can be arbitrarily adjusted by designer as needed) to disturb the outputted control signal Sc, such that the inverting circuit 110 adjust the current cycle of the generated AC output current I_{AC} in response to the control signal Sc. More specifically, the inverting circuit 110 can adjust the power conversion behavior in response to the disturbance signal; so as to reduce or extend the current cycle of the AC output current I_{AC}. For instance: the inverting circuit 110 can suspend power conversion in response to the disturbance signal, such that the current cycle of the AC output current I_{AC} is shortened.

When the power grid EG is in normal operation and connected to the inverting circuit 110 in parallel (i.e., islanding operation does not occur), the zero-voltage cycle of the AC output voltage V_{AC} is restrained at a particular frequency (such as 60 Hz) by the voltage outputted by the power grid EG, and is not affected by a change in the current cycle of the AC output current I_{AC}. On the contrary, when the power grid EG is abnormal and disconnected from the inverting circuit 110, the zero-voltage cycle of the AC output voltage V_{AC} is changed with a change in the current cycle due to lack of restrain from the power grid voltage.

According to the aforementioned characteristic, the control circuit 120 can determine whether the frequency of the AC output voltage V_{AC} is located within the preset frequency range by detecting the zero-voltage cycle of the AC output voltage V_{AC}, so as to accurately determine whether an islanding operation occurs to the inverting apparatus 100.

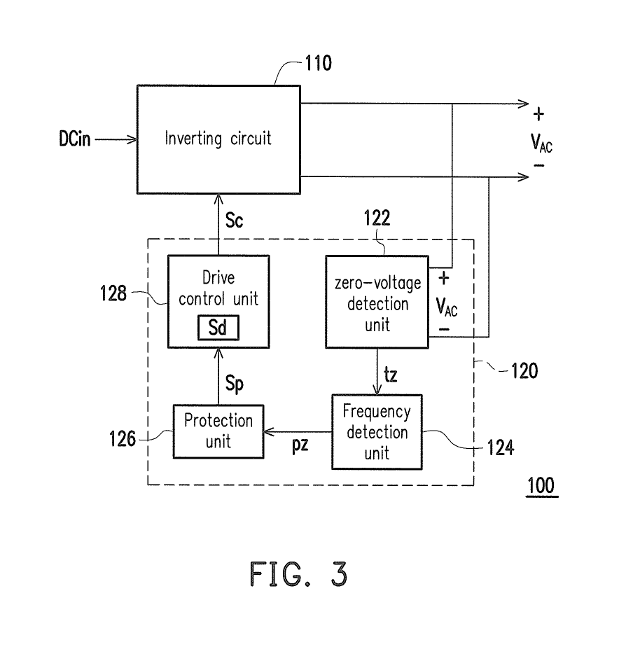

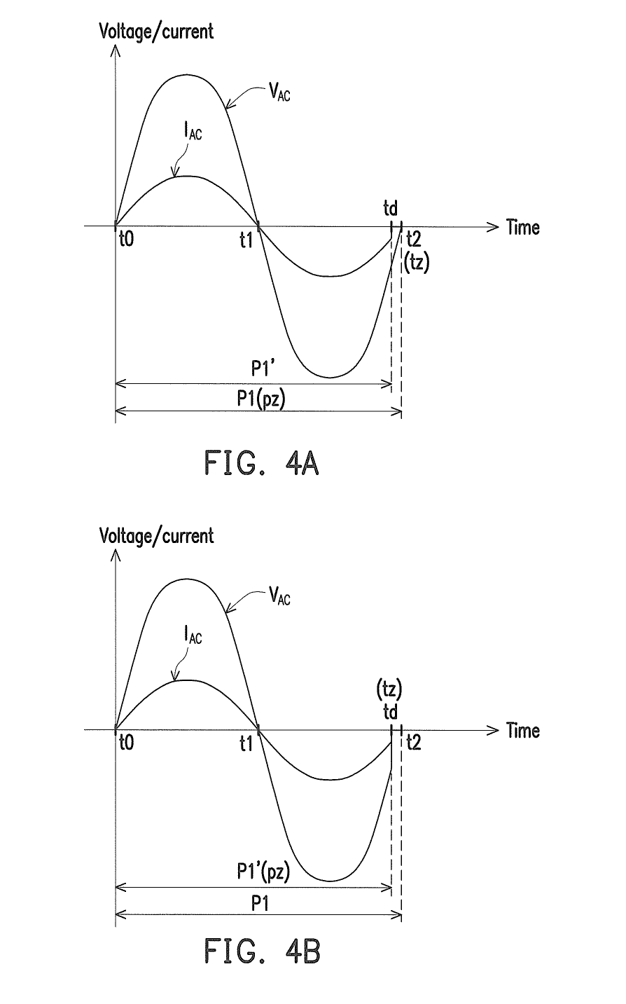

In the following, the specific architectural example shown in FIG. 3 and the voltage waveforms of the AC output voltage V_{AC} shown in FIG. 4A and FIG. 4B are configured to describe how the control circuit 120 achieves the islanding operation detection mechanism. In particular, FIG. 3 is a functional block schematic of a control circuit of an embodiment of the invention. FIG. 4A is a voltage waveform schematic of an AC output voltage of an embodiment of the invention. FIG. 4B is a voltage waveform schematic of an AC output voltage of an embodiment of the invention.

Referring to both FIG. 3 and FIG. 4A, in the present embodiment, the control circuit 120 includes a zero-voltage detection unit 122, a frequency detection unit 124, a protection unit 126, and a drive control unit 128. The zero-voltage detection unit 122 is coupled to the output terminal of the inverting circuit 110 and is configured to detect a zero-voltage time point tz of the AC output voltage V_{AC}. In particular, the zero-voltage time point tz is, for instance, zero-voltage time points t2 and td in FIG. 4A and FIG. 4B.

The frequency detection unit 124 is coupled to the zero-voltage detection unit 122 and is configured to calculate a zero-voltage cycle pz according to the zero-voltage time point tz of the AC output voltage V_{AC}. In particular, the zero-voltage cycle pz is, for instance, zero-voltage cycles p and p1′ in FIG. 4A and FIG. 4B.

The protection unit 126 is coupled to the frequency detection unit 124 to receive the zero-voltage cycle pz calculated by the frequency detection unit 124. In the present embodiment, the protection unit 126 determines whether the zero-voltage cycle pz is located within the preset frequency range, and then sends a protection signal Sp to the drive control unit 128 according to the determination result. In particular, when the protection unit 126 determines the frequency of the AC output voltage V_{AC} is located outside the preset frequency range according to the received zero-voltage cycle pz, the drive control unit 128 adjusts the control signal Sc outputted thereby according to the protection signal Sp, so as to enable the islanding protection mechanism.

From the viewpoint of the overall control behavior of the control circuit 120, first, the drive control unit 128 generates the control signal Sc to control the inverting circuit to operate normally when the drive control unit 128 does not generate a disturbance signal Sd. At this time, the AC output voltage V_{AC} generated by the inverting circuit 110 substantially has the voltage waveform for which the zero-voltage cycle is p1.

When the preset time interval is reached, the drive control unit 128 generates the disturbance signal Sd to disturb the control signal Sc. In particular, the inverting circuit 110 suspends power conversion during the zero-voltage time points td-t2 in response to the disturbed control signal Sc. At this time, if an islanding operation does not occur, referring to FIG. 4A, although the AC output current I_{AC} is set to 0 A at the zero-voltage time point td, the waveform of the AC output voltage V_{AC} is restrained by the power grid voltage such that a voltage waveform of the AC output voltage V_{AC} during the zero-voltage time points td to t2 maintains the original sinusoidal form, and is gradually changed from negative voltage toward zero voltage. In this case, the zero-voltage detection unit 122 detects the zero-voltage time point of the AC output voltage V_{AC} is t2, such that the frequency detection unit 124 accordingly calculates the zero-voltage cycle is p1. Therefore, the protection unit 126 determines the frequency of the AC output voltage V_{AC} is located within the preset frequency range according to the zero-voltage cycle p1, such that the drive control unit 128 does not enable the islanding protection mechanism.

Moreover, if an islanding operation occurs to the inverting apparatus 100, referring to FIG. 4B, the AC output voltage V_{AC} responds to a stop operation of the inverting circuit 110 at the zero-voltage time points td to t2 (AC output current I_{AC} is set to 0 A), and a voltage waveform WF2 for which the voltage value is instantly reduced to zero voltage at the zero-voltage time point td is obtained. In this case, the zero-voltage detection unit 122 detects the zero-voltage time point of the AC output voltage V_{AC} is td, such that the frequency detection unit 124 accordingly calculates the zero-voltage cycle p1′. Therefore, the protection unit 126 determines the frequency of the AC output voltage V_{AC} is located outside the preset frequency range according to the zero-voltage cycle p1′, such that the drive control unit 128 enables the islanding protection mechanism in response to the protection signal Sp.

Based on the above, the embodiments of the invention provide an inverting apparatus and a detection method of an islanding operation. The inverting apparatus can determine whether an islanding operation occurs to the inverting apparatus in a manner in which the inverting apparatus periodically disturbs the AC output current and then detects whether the AC output voltage is changed as a result, so as to accurately and instantly enable the islanding protection mechanism when the islanding operation occurs to prevent damage to a back-end load device.

Lastly, it should be mentioned that: each of the above embodiments is only configured to describe the technical solutions of the invention and is not intended to limit the invention; and although the invention is described in detail via each of the above embodiments, those having ordinary skill in the art should understand that: modifications can still be made to the technical solutions recited in each of the above embodiments, or portions or all of the technical features thereof can be replaced to achieve the same or similar results; the modifications or replacements do not make the nature of corresponding technical solutions depart from the scope of the technical solutions of each of the embodiments of the invention.

What is claimed is:

1. An inverting apparatus, comprising:
an inverting circuit connected to a power grid in parallel, wherein the inverting circuit receives a DC input power, and converts the DC input power into an AC output voltage and an AC output current; and
a control circuit coupled to the inverting circuit and configured to control a power conversion of the inverting circuit, wherein the control circuit generates a disturbance signal base on a preset time interval to disturb the AC output current generated by the inverting circuit, and detects whether a frequency of the AC output voltage is located within a preset frequency range, so as to decide whether to enable an islanding protection mechanism.

2. The inverting apparatus of claim 1, wherein the control circuit determines whether the frequency of the AC output voltage is located within the preset frequency range according to a zero-voltage cycle of the AC output voltage.

3. The inverting apparatus of claim 2, wherein the current cycle of the AC output current is changed by the disturbance signal; when the power grid is in normal operation and connected to the inverting circuit, the zero-voltage cycle is not affected by a change in the current cycle, and when the power grid is abnormal and disconnected from the inverting circuit, the zero-voltage cycle is changed with the change in the current cycle.

4. The inverting apparatus of claim 3, wherein the inverting circuit adjusts a power conversion behavior in response to the disturbance signal, and thus reduces or extends the current cycle.

5. The inverting apparatus of claim 4, wherein the inverting circuit suspends the power conversion in response to the disturbance signal, and thus reduces the current cycle.

6. The inverting apparatus of claim 1, wherein the control circuit comprises:
a zero-voltage detection unit coupled to an output terminal of the inverting circuit and configured to detect a zero-voltage time point of the AC output voltage;
a frequency detection unit coupled to the zero-voltage detection unit and configured to calculate a zero-voltage cycle according to the zero-voltage time point of the AC output voltage;
a protection unit coupled to the frequency detection unit and configured to determine whether the frequency of the AC output voltage is located within the preset frequency range according to the zero-voltage cycle, and sends a protection signal when the frequency of the AC output voltage is not located within the preset frequency range; and
a drive control unit coupled to the protection unit and configured to enable the islanding protection mechanism according to the protection signal, so as to control an operation of the inverting circuit.

7. A detection method of an islanding operation suitable for an AC power distribution system, wherein the AC power distribution system comprises an inverting apparatus and a power grid, the inverting apparatus and the power grid are connected to each other, the detection method comprising:
receiving a DC input power by the inverting apparatus;
converting the DC input power into an AC output voltage and an AC output current by the inverting apparatus;
generating a disturbance signal base on a preset time interval to disturb the AC output current generated by the inverting apparatus;
detecting whether a frequency of the AC output voltage is located within a preset frequency range; and
determining an islanding operation phenomenon occurs to the inverting apparatus when the frequency of the AC output voltage is not located within the preset frequency range.

8. The method of claim 7, wherein the step of detecting whether the frequency of the AC output voltage is located within the preset frequency range comprises:
detecting a zero-voltage time point of the AC output voltage;
calculating a zero-voltage cycle according to the zero-voltage time point of the AC output voltage; and
determining whether the frequency of the AC output voltage is located within the preset frequency range according to the zero-voltage cycle.

9. The method of claim 8, wherein a current cycle of the AC output current is changed by the disturbance signal; when the power grid is in normal operation and connected to the inverting circuit, the zero-voltage cycle is not affected by a change in the current cycle, and when the power grid is abnormal and disconnected from the inverting circuit, the zero-voltage cycle is changed with the change in the current cycle.

10. The method of claim 9, wherein the step of generating the disturbance signal base on the preset time interval to disturb the AC output current generated by the inverting apparatus comprises:
letting the inverting circuit adjusts a power conversion behavior in response to the disturbance signal, so as to reduce or extend the current cycle.

11. The method of claim 10, wherein the step of letting the inverting circuit adjusts the power conversion behavior in response to the disturbance signal, so as to reduce or extend the current cycle comprises:
letting the inverting circuit suspends the power conversion in response to the disturbance signal, so as to reduce the current cycle.

12. The method of claim 7, further comprising:
enabling an islanding protection mechanism when the islanding operation phenomenon is determined to occur to the inverting apparatus.
